(19) United States
(12) Patent Application Publication
(10) Pub. No.: US 2012/0246667 A1
(43) Pub. Date: Sep. 27, 2012

(54) System and Method of Using Symbology to Purchase Broadcast Media

(75) Inventor: Leigh M. Rothschild, Sunny Isles Beach, FL (US)

(73) Assignee: LMR Inventions, LLC, Sunny Isles Beach, FL (US)

(21) Appl. No.: 13/471,135

(22) Filed: May 14, 2012

Related U.S. Application Data
(63) Continuation-in-part of application No. 11/292,613, filed on Dec. 2, 2005.

(51) Int. Cl. H04N 21/2543; H04N 21/45

(52) U.S. Cl. 725/1; 725/25

(57) ABSTRACT

A method, controller and system in accordance with various aspects of the present disclosure facilitate automatic acquisition of broadcast content for a user. Within the method, controller and system, a user device having a digital imaging device, a controller, and at least one network interface is configured to scan a visual code overlaid on visual broadcast content displayed on a display device. The user device interprets the scanned visual code to identify the visual broadcast content, and retrieves user preferences stored on the user device to facilitate acquisition of the stored content by the user. The user preferences identify a user-preferred site for acquiring the broadcast content, and may identify other parameters as well. The user device then establishes a transaction between the user device and the user-preferred site to acquire the broadcast content. In an embodiment, mere acceptance of the transaction by the user completes the transaction.

### RELATED APPLICATION

This application is a continuation in part of U.S. application Ser. No. 11/292,613, filed on Dec. 2, 2005, entitled “SYSTEM AND METHOD FOR OBTAINING INFORMATION ON DIGITAL MEDIA CONTENT,” which claims priority to U.S. application Ser. No. 11/125,929, filed on May 10, 2005, entitled “SYSTEM AND METHOD FOR CONTROLLING A PLURALITY OF ELECTRONIC DEVICES,” the entirety of both applications being herein incorporated by reference for all that they teach without exclusion of any part.

### TECHNICAL FIELD OF THE DISCLOSURE

The present disclosure relates generally to interfacing with an appliance, and more particularly, to employing symbology to facilitate the purchase or rent of broadcast media.

### BACKGROUND OF THE DISCLOSURE

While watching television used to be a scheduled activity, the advent of digital recording on a large scale has now made time-shifting of content possible. Indeed, many users now watch broadcast content at their convenience rather than at a broadcaster-scheduled time. In addition to enhancing user convenience, the digital recording era has allowed broadcasters to make their content available through other channels, e.g., web sites, for purchase or rental by users.

However, the process for accessing such content by users is still an awkward one compared to the ease of simply watching broadcast TV. For example, a transaction to purchase or rent content typically requires a user to identify the content of interest, locate a web site that has such content, find the content on the site, and executing an exchange of information, e.g., ecommerce data, to complete the purchase or rental.

Therefore, a need exists for systems and methods that enable a user to more easily access content for purchase or rent based on viewing a portion of the content or based on viewing information about the content, e.g., a synopsis or guide entry. It should be appreciated however, that this background section discusses problems and solutions noted by the inventor; the inclusion of any problem or solution in this section is not an indication that the problem or solution represents known prior art except as otherwise expressly noted. Thus, the foregoing description is not intended to represent prior art nor to alter or supplement the prior art.

### SUMMARY OF THE DISCLOSURE

In accordance with an aspect of the present disclosure, a system and method are provided for facilitating automatic acquisition of broadcast content for a user of a user device. To this end, the user device includes a digital imaging device, a controller, and at least one network interface, and is configured to scan a visual code overlaid on visual broadcast content displayed on a display device. Configuration of the user device in this manner may be via a resident application. The digital imaging device can take the form of a camera, tablet device, mobile phone, PDA, and so on. Although any one of various image capture technologies may be employed, the digital imaging device contains a charged coupled diode (CCD) array, in an embodiment, to capture and then store digital images.

Using the application, the user device interprets the scanned visual code to identify the visual broadcast content, and retrieves user preferences stored on the user device to facilitate acquisition of the stored content by the user. The user preferences identify, for example, a user-preferred site for acquiring the broadcast content, and may identify other parameters as well, such as whether the user prefers to rent or purchase, whether the user prefers episodes or entire seasons, and so on. The user device then establishes a transaction between the user device and the user-preferred site to acquire the broadcast content. In an embodiment, mere acceptance of the transaction by the user completes the transaction.

Additional and alternative features and aspects of the disclosed methods and systems will become apparent from reading the detailed specification in conjunction with the included drawing figures.

### BRIEF DESCRIPTION OF THE DRAWINGS

FIG. 1 is a diagram of a system for controlling at least one electronic device in accordance with an embodiment of the present disclosure;

FIG. 2 is a schematic diagram of a controller in accordance with an embodiment of the present disclosure;

FIG. 3 is a schematic diagram of a transmitter in accordance with an embodiment of the present disclosure;

FIG. 4 is a flowchart illustrating a method for programming the controller;

FIG. 5 is a flowchart illustrating a method for controlling an operation of at least one electronic device in accordance with the present disclosure;

FIG. 6 illustrates several display views for describing various operations of the system of the present disclosure;

FIG. 7 illustrates a system for obtaining information on digital media content according to an embodiment of the present disclosure;

FIG. 8 is a flowchart illustrating a method for obtaining information on digital media content;

FIG. 9 illustrates several display views of the system for obtaining information on digital media content in accordance with an embodiment of the present disclosure;

FIG. 10 is a simulated display view showing a manner of placement of a code overlay with respect to displayed content;

FIG. 11 is a schematic view of a mobile user device within which an embodiment of the disclosed principles is implemented;

FIG. 12 is a logical diagram of an application in accordance with an embodiment of the disclosed principles, showing various modules for taking specific actions; and

FIG. 13 is a flow chart illustrating a process of accessing content via symbology in accordance with an embodiment of the disclosed principles.

### DETAILED DESCRIPTION OF THE DISCLOSURE

This disclosure relates to using symbology such as QR codes and the like to allow a user to purchase or rent broadcast media for anytime viewing on their computer, tablet, phone, or streaming device at their convenience. In overview, the broadcaster tags the content with visible QR CODES, barcodes, MICROSOFT tag codes or the like to allow the user to scan the code using their mobile device and then automatically elect to purchase or rent the selected content. Stored ecommerce data on the user device allows the user to merely scan the visible code, select any options and elect to purchase.

Preferred embodiments of the present disclosure will be described herein below with reference to the accompanying drawings. In the following description, well-known functions or constructions are not described in detail to avoid obscuring the present disclosure in unnecessary detail.

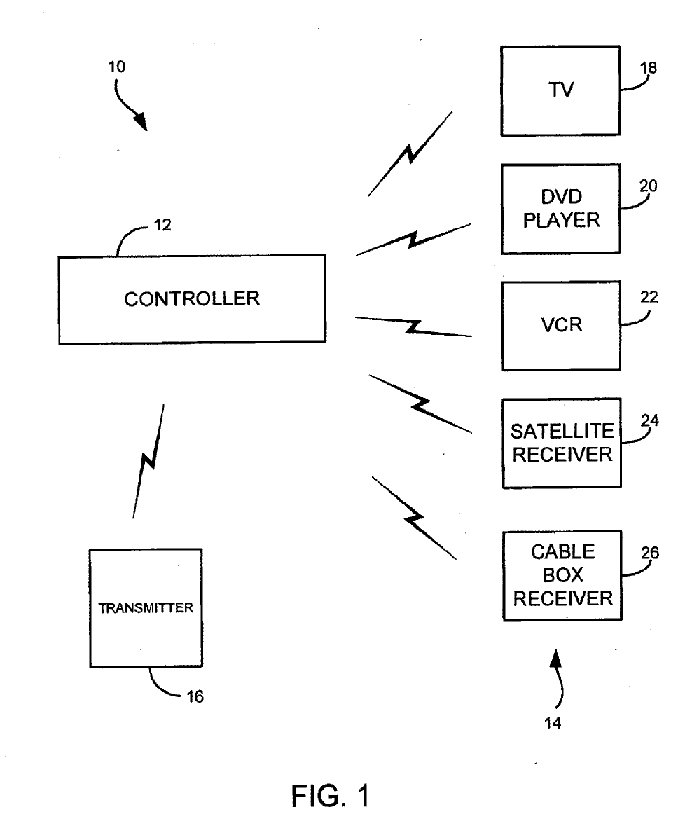

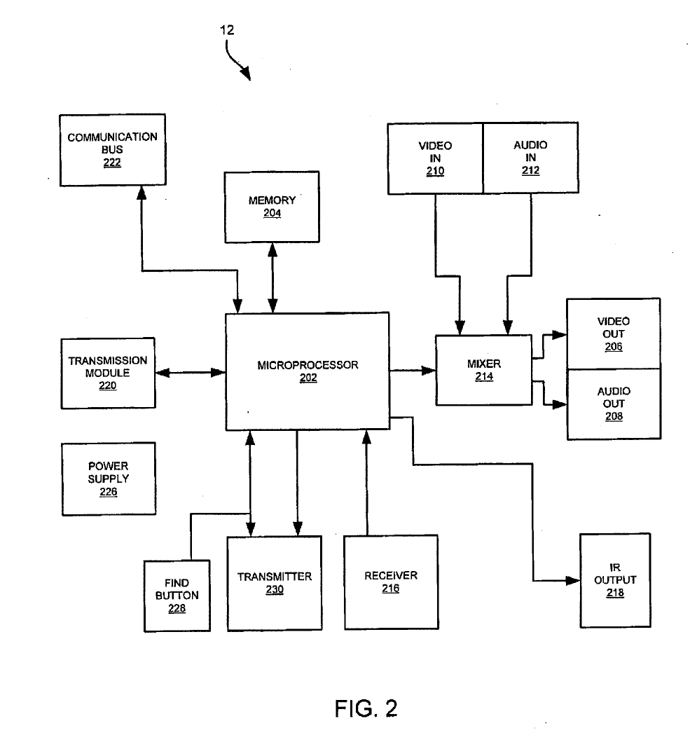

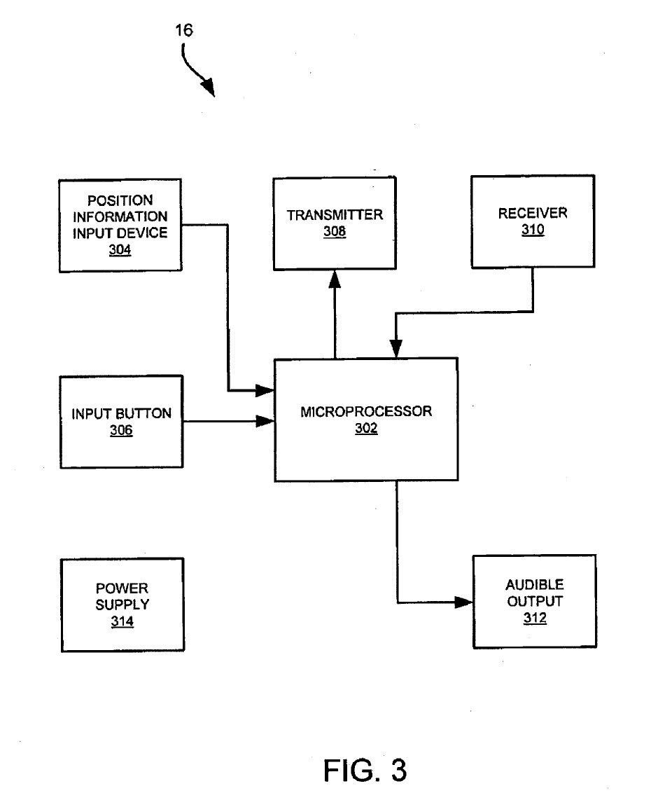

Referring to FIG. 1, a system for controlling an operation of at least one of a plurality of electronic devices or appliances is generally represented by the numeral 10. The system 10 includes a controller 12 for generating a graphic representation of at least one remote control device to be displayed on a display device, for receiving an input command relating to the at least one graphic and for generating and transmitting a control signal in response to the input command to at least one of a plurality of electronic devices 14. The electronic devices may include any known electronic appliance or component commonly employed in a home entertainment system, e.g., a television 18, a digital video disc (DVD) player 20, a VCR 22, a satellite receiver 24, a cable box receiver 26, etc. The electronic devices may further include lighting systems and computer systems. The system 10 further includes a remote control transmitter 16 for generating and transmitting command signals to the controller 12. Both the controller 12 and transmitter 16 will be described in more detail below with reference to FIGS. 2 and 3.

The controller 12 includes a microprocessor 202 for controlling the overall operations of the controller 12. A memory 204 is coupled to the microprocessor 202 and stores a plurality of graphic representations and command codes associated with a particular electronic appliance. The graphic representation is an image of the remote control device associated with a particular electronic appliance. The command codes that would normally emanate from the remote control are stored along with the graphic and will be employed to control the electronic appliance as will be described in more detail below.

A video output port 206 for outputting a video signal to a display, e.g., a television, CRT monitor, etc., and an audio output port 208 for outputting an audio signal are provided. The video output port 206 may be any known output interface including but not limited to a composite output, S-video, video graphics array (VGA), digital video interface (DVI), etc. The video output port 206 is coupled to the microprocessor 202 and receives the graphic of the remote control device and transmits the graphic to a display device. The controller 12 further includes a video input 210 and audio input 212 that are coupled to the video output port 206 and audio output port 208 via a mixer 214. In one state, the mixer 214 will receive signals from the video input 210 and audio input 212 and pass them straight through to the video output port 206 and audio output port 208. Here, the video input 210 and audio input 212 are basically pass-through jacks that mirror the original jacks, or ports, on the display device to allow a user to utilize the input jacks or ports of the display device even when the controller 12 is connected thereto. In another state, the mixer 214 will superimpose a graphic of a remote control device onto the video signal received from the video input 210. The superimposed graphic may consume the whole screen of the display device or may act as a pop-up on a small portion of the viewable area of the display.

A receiver 216 is provided for receiving positional information from the transmitter 16 and transmitting the positional information to the microprocessor 202. Once the graphic is displayed on the display, the transmitter 16 will act as a cursor control device to align a pointer over a specific function button on the remote control graphic. The receiver 216 will determine the cursor position information and send it to the microprocessor 202 which will generate a pointer in the relative position on the graphic. The receiver 216 may be a photosensor for receiving infrared signals or may be a conventional receiver operating under any of the various known wireless protocols including but not limited to Bluetooth™ interconnectivity, radio transmission connectivity including computer digital signal broadcasting and reception commonly referred to as Wi-Fi or 802.11x (where x denotes the type of transmission), or any other type of communication protocol or system currently existing or to be developed for wirelessly transmitting data.

Once a control function has been determined by the microprocessor 202 by determining the pointer location on the remote control graphic, the microprocessor will retrieve the proper control code from the memory 204 and transmit the control code to the appropriate electronic device via an infrared (IR) blaster 218, as is known in the art. An exemplary IR blaster is model IR-200L commercially available from ACTiSYS Corp. of Fremont, Calif. The infrared blaster 218 will transmit the control code via a series of infrared light pulses as would the original remote control device associated with the particular electronic appliance. The IR blaster 218 preferably is integral within a housing of the controller 12 but may located remotely from the controller to be in close proximity to the IR receiver of the particular electronic appliance.

The controller 12 further includes a transmission module 220 for coupling the controller 12 to a global computer network, e.g., the Internet, to enable data transmission between the controller 12 and other computing devices, e.g., a web server. The transmission module 220 may be but not limited to a network interface card (NIC), e.g., an Ethernet card, a WI-FI card, a Bluetooth™ transceiver, an analog/digital modem or any other known data transmission device. As will be described in more detail below, the controller 12 will access a web server during initial setup and programming to retrieve further graphics and codes as new remote control devices are added to the system.

In an embodiment, a user accesses an established website on the Internet to register the controller 12 and existing remote control device models. A download then occurs to the controller 12 of images and bitmap charts of the remote controls selected and also the code sets for the remote control devices to be utilized with the IR blaster 218. By way of example, if a Phillips™ remote control for a VCR is registered, and the user desires to download the associated data, an image of that remote and bit map/programming would be downloaded and stored in memory in the controller 12. The controller 12 would then interpret when the transmitter 16 aligns points on the image of the remote, and subsequently, specific IR signals would be emitted from the IR blaster 218 to control the Phillips™ VCR.

The controller also includes a communication bus module 222 for coupling a plurality of controllers 12 together via a daisy-chained hardwire connection. By locating several controllers throughout a location, e.g., a home, the controllers can be located near electronic appliances located in various locations allowing a user to have control over the various electronic appliances from any controller location. The communication bus module 222 may additionally couple a plurality of infrared repeaters to the controller 12 for controlling electronic devices located remotely from the controller 12.

Optionally, the controller 12 may include a find button 228, e.g., a momentary switch, which when depressed will initiate a locate signal to the remote control transmitter 16. The find button 228 may be directly coupled to a transmitter 230 or may be indirectly coupled to the transmitter 230 via the microprocessor 202. The operation of the find button and locate signal will be described in more detail below in relation to the remote control transmitter 16.

A power supply 226 is coupled to at least the above-mentioned components for supplying power to each component. Preferably, the power supply 226 is externally powered by AC current. The power supply 226 preferably also includes a battery back-up for retaining the contents of memory 204 in the event of a power supply failure.

It is to be understood that the present disclosure may be implemented in various forms of hardware, software, firmware, special purpose processors, or a combination thereof. A system bus couples the various components shown in FIG. 2 and may be any of several types of bus structures including a memory bus or memory controller, a peripheral bus, and a local bus using any of a variety of bus architectures. The system also includes an operating system and micro instruction code. The various processes and functions described herein may either be part of the micro instruction code or part of an application program (or a combination thereof) which is executed via the operating system.

It is to be further understood that because some of the constituent system components and method steps depicted in the accompanying figures may be implemented in software, the actual connections between the system components (or the process steps) may differ depending upon the manner in which the present disclosure is programmed. Given the teachings of the present disclosure provided herein, one of ordinary skill in the related art will be able to contemplate these and similar implementations or configurations of the present disclosure.

In one embodiment of the present disclosure, the controller or controller components is hardwired to, and resident in, a television or an ancillary device connected to a television or entertainment device such as a cable television control device, satellite television control device, Tivo™ or other type of personal (digital) recording device, DVD player, VCR, personal media computer, or any other type of device that is coupled to a display device or monitor.

Referring to FIG. 3, a remote control transmitter 16 in an embodiment of the present disclosure is illustrated. The transmitter 16 includes a microprocessor 302 for controlling the overall operations of the transmitter 16, receiving input information and generating command signals to be transmitted to the controller 12. The transmitter 16 includes a positional information input device 304, e.g., a touch pad, for generating a relative position information signal which will be transmitted to the controller 12. The positional information input device 304 will control the pointer or cursor on the display for selecting a function on the graphic of the selected remote control device. The transmitter 16 also includes at least one input button 306 for confirming selection of a control function on the graphic of the remote control. Alternatively, the user will tap the positional information input device 304 when the pointer is in the appropriate location to confirm selecting of the control function.

The microprocessor 302 will receive the input signals generated by positional information input device 304 and the at least one button 306 and will generate a command signal that will be transmitted to the controller 12 by transmitter 308. The transmitter 308 will operate under a compatible protocol with the receiver 216 of the controller 12.

The transmitter 16 will further include a receiver 310 for receiving data from the controller 12. Preferably, the receiver 310 will receive a locate signal from the controller 12 and transmit the received locate signal to the microprocessor 302 which will in turn generate a signal to activate an audible output 312, e.g., a speaker, buzzer, tone generator, etc. In this manner, upon depressing the find button 228 on the controller 12, the transmitter 16 will produce an audible sound facilitating a user locating the transmitter 16.

Furthermore, a power supply 314 is coupled to at least the above-mentioned components for supplying power to each component of the remote controller transmitter 16.

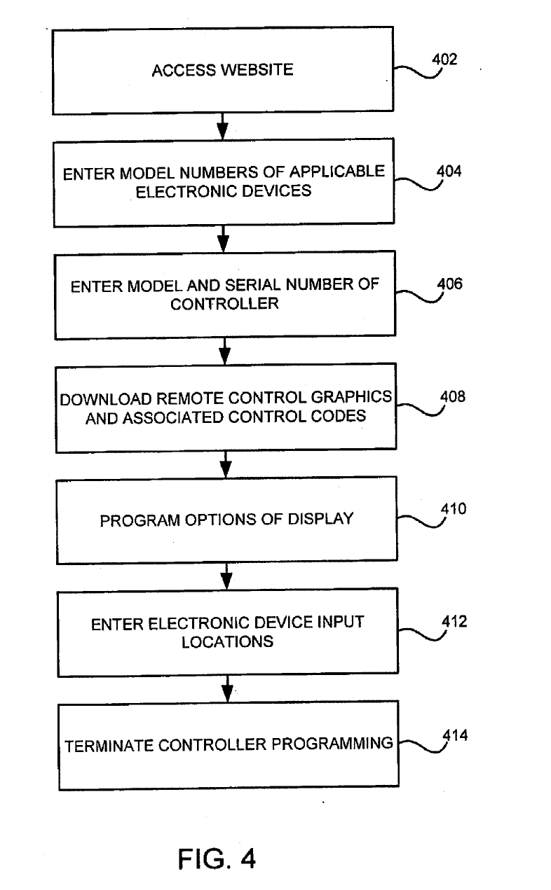

A method for programming the controller 12 will now be described with reference to FIG. 4. Initially, in step 402, a user accesses a designated website. The user is prompted to enter the model numbers of their applicable devices, e.g., television, DVD player, etc. in a registration form (step 404). Then, in step 406, the user is prompted to enter the model and serial number of the controller 12 in their possession and to indicate a network connection of the controller 12 (and type of connection, e.g., Bluetooth™, wired, WiFi, etc). A web server then contacts the controller 12 through a local network connection and sets up the controller 12, where the microprocessor 202 is programmed with executable instructions, and software is now resident to display various remote control graphics (step 408). The control codes associated with each electronic device and/or remote control is also downloaded and stored in memory 204.

Optionally, the user may also designate any existing remote control as the remote to replace the transmitter 16 by entering at the website the model number and manufacturer of the existing remote control, and the controller 12 will then accept IR input from the designated remote control device.

In step 410, the user instructs controller 12 during setup, either through the global computer network or, alternatively at the controller 12 itself, how the remote control graphic is to be displayed during use. For example, the user may select a color of TV background, whether the graphic is a full overlay or see through overlay, a position for the pop-up graphic to appear, and size of pop-up, time for overlay to appear, tactile information (such as occurs during computer mouse setup), order for remotes to be displayed in, whether graphic remotes appear, or just keyboard remote choices. Following this step, the user may check to see if all remote controls are displayed on the screen.

Next, in step 412, the user instructs the controller 12 where each electronic device or appliance is located on the display/TV inputs. For example, a DVD player may correspond to video input number one, a VCR may correspond to video input 2, a high def sat may be associated with dvi-1, cable may be associated with ant A, Tivo™ may be associated with input-2, etc. At this point, the controller 12 is programmed and the setup procedure is terminated (step 414). The user may now employ the single transmitter 16 to control the plurality of electronic devices.

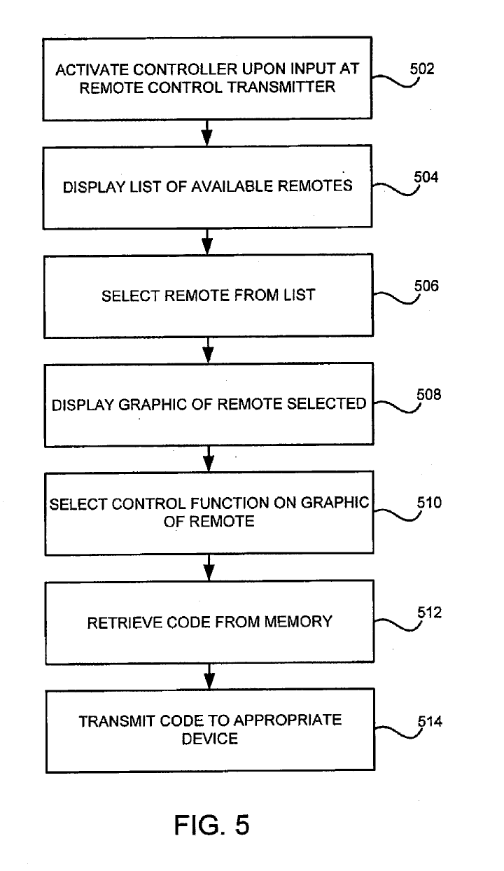

Referring to FIG. 5, a method for controlling an operation of at least one electronic device in accordance with the present disclosure is illustrated. Initially, in step 502, the user will activate the controller 12 upon any input at the remote control transmitter 16, e.g., by clicking one of the buttons 306 or touching the touch pad 304. Once the user activates the controller 12, a pop up will appear, either replacing an image on the display or overlaying the image on the display, listing the remotes and/or electronic devices that have been programmed into the system (step 504). In step 506, the user can scroll down with the position information input device 304 on the remote transmitter 16 to pick the remote or device they want. Next, a remote graphic or picture of the remote selected appears (step 508).

Once the graphic of the remote is displayed, the user can then operate the selected remote through the transmitter 16 with scroll controls and button controls (step 510). Using the touch pad, the user aligns a pointer or cursor on a control button of the displayed graphic, e.g., a play button, and selects the functions with a click of the at least one button 306. The controller 12 correlates the position that the user has selected on the remote graphic, and using standard programming instructions and processing power of the microprocessor 202, the controller 12 retrieves the appropriate control code from memory 204 (step 512). Then, the controller 12 orders the IR instruction code for the position selected on the remote control to be emitted (blasted) from the IR blaster 218 to the entertainment devices. Entertainment devices are thus controlled with a single small remote transmitter 16 (or the user's existing remote if selected) and all remote control images can be resident on screen whenever they are needed. The remote transmitter can control any function available on the selected remote, e.g., change a channel, adjust volume, play a DVD, fast forward a video tape, etc.

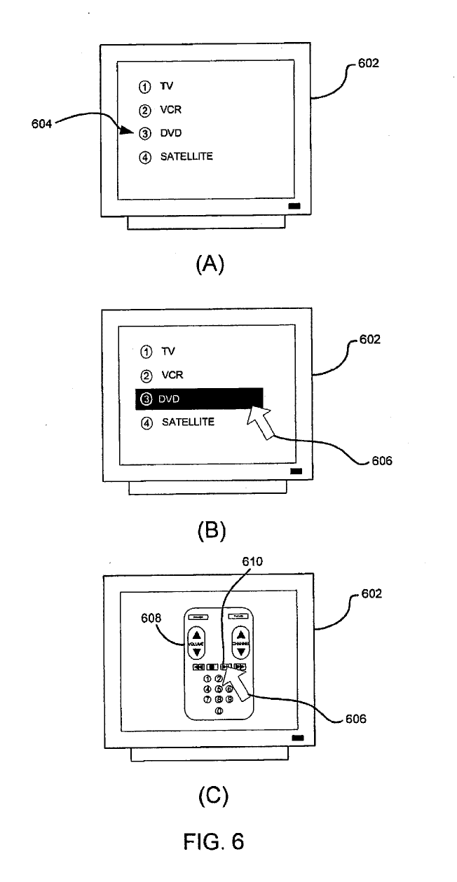

To further illustrate the operations of the system 10 of the present disclosure, FIG. 6 shows several display views generated by the system 10. Initially, the user signals the controller 12 to display a list 604 of remotes on a display device 602, e.g., a television (see FIG. 6A). Using the touch pad on the transmitter, the user moves the pointer 606 to select the DVD player (see FIG. 6B). Then, the DVD player remote appears and, at the same time, the controller 12 transits a signal via the IR blaster 218 to switch TV input to the input that the DVD player is located on, which it knows from user setup described above. The graphic 608 of the selected remote remains overlaid on the screen of the display 602 as shown in FIG. 6C. The user may then select “DVD play” on the remote graphic 608 by scrolling and then clicking on the play button 610. The controller then blasts the DVD player to start a play sequence. The user may then watch the movie and remote overlay disappears after a predetermined, user adjustable time. At a later time, the user may click the transmitter 16 and the last graphic (e.g., DVD remote) appears. The user may then scroll to and then click the pause button and the controller 12 blasts the DVD player to pause. The user may then click another button of the at least one button 306 and the list of all remotes in the system appears (FIG. 6A). The user aligns and clicks “TV,” and an image of the TV's remote pops up on screen. The user clicks the power button on the graphic of the TV remote and the TV shuts down.

In another embodiment of the present disclosure, a user can network at least one other controller 12, which is Ethernet/Bluetooth/Wi-Fi connected, to a remote display/television location. The output of the display/television would be connected to the input on the controller. The user may then from a main location also control remotely located devices such as a Tivo™ control device, etc., if such devices have a video output. This video output may be streamed from the remote location controller to the main controller on the local computer network (either WiFi or Ethernet wiring, or Bluetooth, etc.) and the user may then see this streamed content output from the main controller video output signal which is input to the local display device.

In a further embodiment, the controller is resident in an entertainment device and, using a local or global computer network, communicates (via Wi-Fi/Bluetooth or other wired or wireless link) the status of the device to a user. The status information includes but is not limited to: power on/power off, audio volume, channel indication, signal frequency indication, internal temperature, power consumption, storage space, e.g., memory, for a resident digital storage device both free and utilized, sharpness of image, brightness of image, color of image, convergence aspects of display tube, etc. This information may be viewable by the user at a website or may be e-mailed to the user. Alternatively, a manufacturer of the entertainment device may receive the information and contact the user if they detect a possible malfunction with the device.

A system and method for controlling an operation of at least one electronic device, e.g., an entertainment device, has been described. The system and method of the present disclosure eliminates the need for a multitude of remote controls, simplifies the programming of a plurality of remotes into a single device, e.g., transmitter 16, is totally scalable and upgradeable, and the remote control transmitter 16 has a very small form factor.

In further embodiments of the present disclosure, a system and method for obtaining information on digital media content played on the electronic devices are provided. The system and method obtain information on the digital media content by querying the media content through a remote server on a global computer network, e.g., the Internet, via a remote control device, e.g., transmitter 16, that uses one button for the query. The system and method enables a user to obtain information on media content, e.g. DVDs, audio or computer CDs, prerecorded video files such as Tivo™ files, personal video recorder files (PVR), etc., by clicking one button on the remote control, e.g., transmitter 16, while watching or listening to the content. The controller 12 then queries a remote server for the requested information and displays this information on a display device coupled to the controller 12. The user is able to obtain specific information on the content, conduct e-commerce transactions on the content or direct specific actions by the media player or electronic device (e.g., the computer, cable box, or DVD player, etc.) such as recording the content to a remote device, a portable device, another computer on the network, etc.

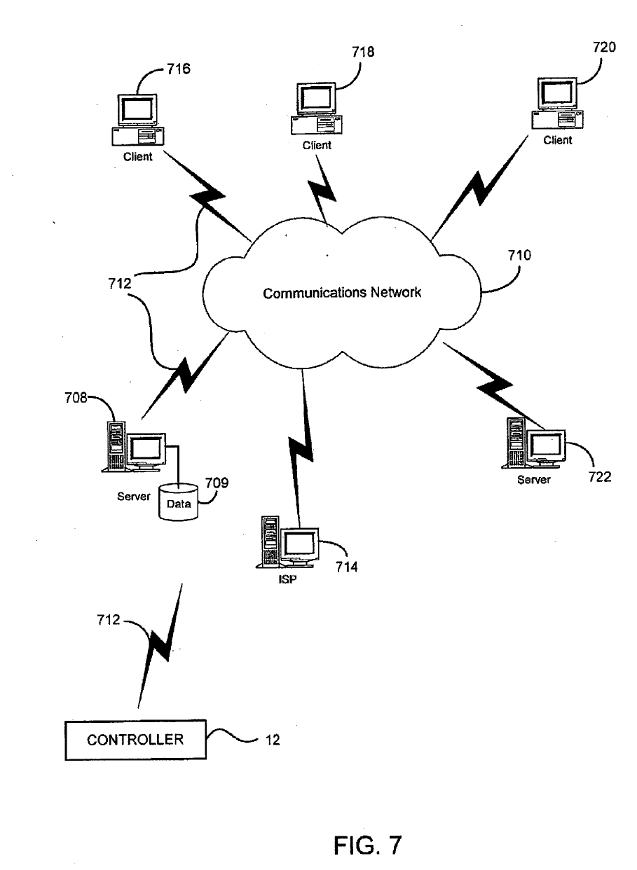

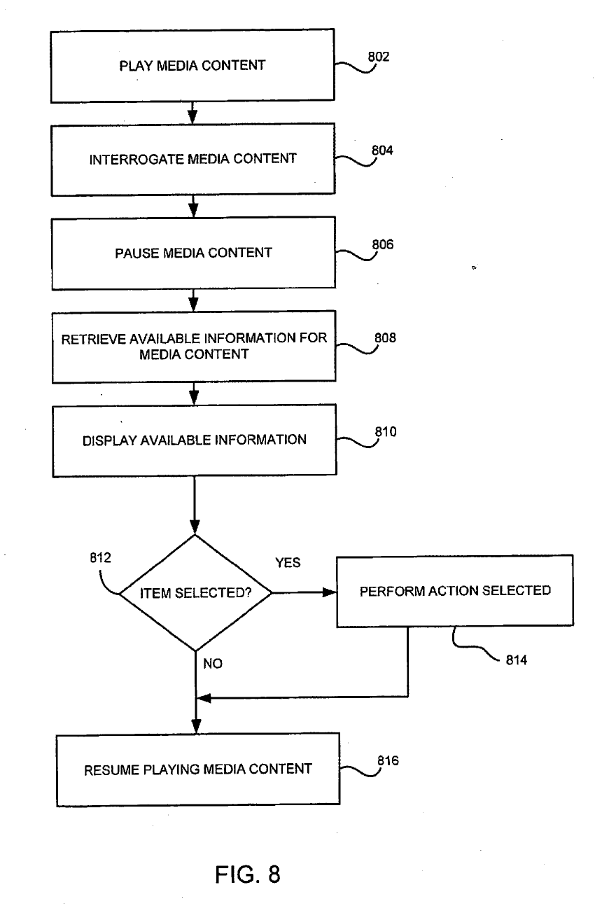

A system and method for obtaining information on digital media content by querying the media through a remote server will be described by reference to FIGS. 7 and 8. Referring to FIG. 7, the controller 12 will communicate to a remote server 708 via a communication network 710. The controller 12 and server 708 may be connected to the communications network 716, e.g., the Internet, by any known means, for example, a hardwired or wireless connection 712, such as dial-up, hardwired, cable, DSL, satellite, cellular, PCS, wireless transmission (e.g., 802.11a/b/g), etc.

It is to be appreciated that the network 710 may be a local area network (LAN), wide area network (WAN), the Internet or any known network that couples a plurality of computers to enable various modes of communication via network messages. Furthermore, the server 708 will communicate using the various known protocols such as Transmission Control Protocol/ Internet Protocol (TCP/IP), File Transfer Protocol (FTP), Hypertext Transfer Protocol (HTTP), etc., and secure protocols such as Internet Protocol Security Protocol (IPSec), Point-to-Point Tunneling Protocol (PPTP), Secure Sockets Layer (SSL) Protocol, etc. The server 708 will further include a storage medium 709 for storing a database of information related to digital media content as will be described in more detail below.

Alternatively, the controller 12 may connect to the network 710 via an Internet Service Provider (ISP) 714, where once connected, the ISP server 714 will manage the flow of information from the controller 12, e.g., transmitting a request for information to the server 708, e-mailing to other users 716, 718, 720 of the network 710, transmitting digital media content to other computing devices, and/or manage the flow of information from various web sites connected to the network 710, e.g., content providers residing on server 722. Furthermore, the ISP 714 may include a mail server for handling electronic mail, e.g., e-mail. The mail server will include the appropriate applications and/or servers for handling incoming mail; e.g., Simple Mail Transfer Protocol (SMTP), and outgoing mail, e.g., Post Office Protocol 3 (POP3).

Although the physical environment shows the connected devices as computers, such illustration is merely exemplary and indicates any of various digital devices, such as PDAs, network appliances, notebook computers, portable media centers, etc. The computing devices may communicate to the servers 708, 714, 722 and network 710 via any known communication link 712, for example, dial-up, hardwired, cable, DSL, satellite, cellular, PCS, wireless transmission (e.g., 802.11 a/b/g), etc.

Referring to FIG. 8, the controller 12 will command the appropriate electronic device to play the desired media content as described above (step 802). For example, the controller may instruct a DVD player to play a movie disc that is in the player or may instruct a digital video recorder to play a recorded movie or TV show. While the media content is playing, the user may instruct the controller 12 to interrogate or request information relating to the media content or a portion of the media content currently being played (step 804). The user will instruct the controller 12 via the transmitter 16.

The transmitter 16 may be programmed so that after a play mode has been activated, the input button 306 will send an interrogate signal to the controller 12 upon its next activation. Alternatively, the position information input device 304, e.g., a touch pad, will have a portion designated as the interrogate signal such that upon an input, an interrogate signal will be generated. Therefore, a user will be able to request information related to the media content upon activation of a single button.

Upon receiving the interrogate signal, the controller will pause the media (step 806) and will retrieve available information related to the media content from server 708 (step 808). To retrieve the information, the controller 12 will generate a request or query that will be transmitted to the remote server 708 via transmission module 220. The request will include at least one identifier of the media content, e.g., at least the title of the work, movie title, song title, etc., read from the media, e.g., read from the DVD or read from memory of the DVR where the content is stored, etc. The request may also include a time the request was generated as measured from the start of the content.

The request will be received by the server 708 and will be used to query the database 709. The database 709 will include at least one table of information including a plurality of data fields relating to at least one digital media content. The data fields may include but are not limited to date of creation, author/creator of content, publisher, web site address of creator/publisher, actor/actress featured in content, e-mail address of actor/actress, web site address of actor/actress, information on products shown in movie/TV show, etc.

The database 709 may also include tables for each media content, e.g., a table broken down into time increments with each time increment including a plurality of data fields. The time increments represent segments of the content according to a running time of the media content measured from the start of the media content. The data fields associated with the time increments may include but are not limited to product information of a product that appeared in the segment, web site address of e-commerce site to purchase a product shown in the segment, actor/actress that appeared in the segment, web site address of an actor/actress that appeared in the segment, etc.

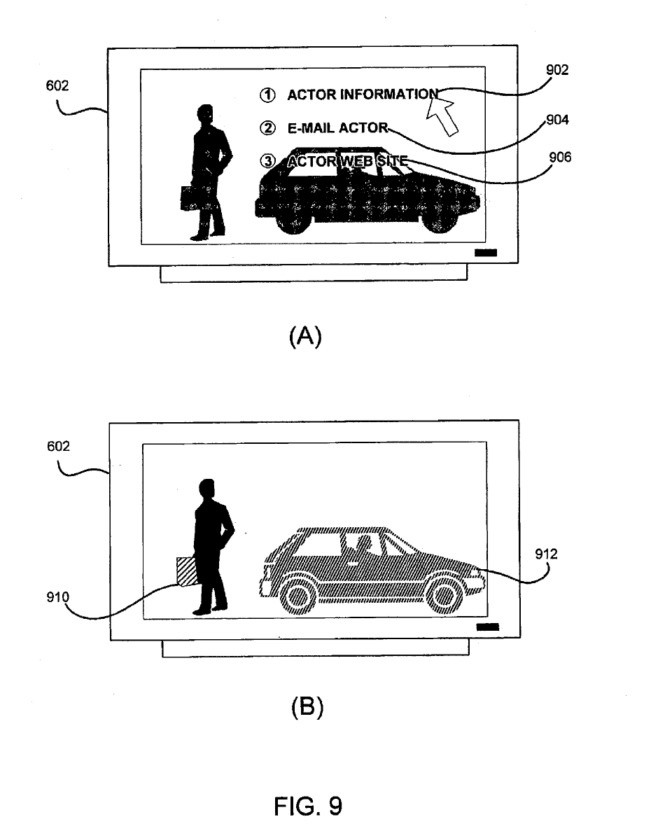

The remote server 708 will then retrieve the information associated with the media content from the database 709 and transmit the information to the controller 12 to be displayed on the display device (step 810). The controller 12 will then receive the information and overlay the information over the paused content. The information may contain a plurality of items and may be displayed on the display device 602 as a list of items such that the user is able to select an item to receive further specific information, as shown in FIG. 9A. In FIG. 9A, three items are overlaid on the paused content: actor information 902, e-mail actor 904 and actor website 906.

The user can then select an item using the transmitter 16 by positioning a pointer over the item via the position information input device 304 (step 812). The user will then select the item and the controller will perform the appropriate action (step 814). For example, if the user selects actor information 902, the controller will retrieve from the remote server information on the actor such as a biography; if the user selects e-mail actor 904, the controller will access the user's e-mail program for sending an e-mail to the actor; and if the user selects actor web site 906, the controller 12 will direct the user to the web site of the actor via an appropriate web browser. After the selected action is completed, controller 12 will resume playing the media content (step 816).

In another embodiment, the interrogation request will be made for a specific time of the media content, for example, when the user observes an item in which they are interested. In this embodiment, the controller 12 will transmit the request to the server 708 with a time measured from the start of the media content in addition to the identifier of the media content. The server will then access the database 709 and retrieve information for that time increment. The information will then be transmitted to the controller 12 for display. The list of items can include, for example, products that are visible at the time the interrogation signal was generated. In this example, upon selection of a product from the list, a second list will appear with specific action items for the selected product, e.g., conduct e-commerce transaction to purchase product, go to web site of product, receive e-mail regarding product, etc.

In yet another embodiment, when a request is made for a specific time of the media content, the controller 12 will pause the media content and highlight items on the display for which information is available. The controller 12 will receive information on the items from server 708 and, using image segmentation as is known in the art, will identify the items in the paused image on the display, segment the items and highlight the items to distinguish to a user that information is available on that item. Referring to FIG. 9B, the display device 602 illustrates the paused media content with several items highlighted, e.g., a briefcase 910 and car 912. In FIG. 9B, the items with hatched lines represent highlighted items. The user will then select one of the highlighted items and will be presented with a list of action items as described above.

While the user may desire to perform certain actions associated with media content (e.g., identify actors, products, etc.) or with the playing of the media content (e.g., pause, play, stop etc.) as described above, the user may also desire to purchase or rent the content itself. This is especially applicable in a broadcast context wherein the user would normally access the content at a broadcaster-scheduled time via a broadcast media such as cable TV media, Internet TV media, and so on. In this connection, in a further embodiment of the disclosed principles, a system and method are provided for employing symbology and associated conversion and interpretation to allow a user to easily perform a commercial transaction associated with broadcast content, e.g., purchasing or renting the content.

It will be appreciated that broadcast content is now frequently available not only for instant viewing when scheduled, but also for rental or purchase for later viewing. A number of Internet sites, in cooperation with the media providers, can be accessed to rent or purchase content. Such sites include sites hosted by Amazon™, ITunes™, and so on, and the purchase or rental of content allows the user to download the content for anytime viewing on their computers, tablets, phones, or streaming devices (such as ROKU or APPLETV) at their convenience. However, it is currently difficult for occasional users to purchase or rent content, because such a transaction currently involves accessing an appropriate website, locating and selecting the content of interest, and instituting the ecommerce transaction that will lead to the purchase/rental, including all necessary data entry and information exchange.

In an embodiment, a system is provided wherein a broadcaster tags content with visible symbology as noted above, e.g., a QR CODE, barcode, MICROSOFT tag code, etc., such that the user is able to scan the code with a mobile device (IPHONE, ANDROID, WINDOWS MOBILE, BLACKBERRY, etc.) and then simply elect to purchase or rent the content. As will be discussed in greater detail below, the user device may contain and employ stored ecommerce data (credit card and personal information) associated with the user, so that the user can simply scan the code and make an election or selection to complete the purchase or rental.

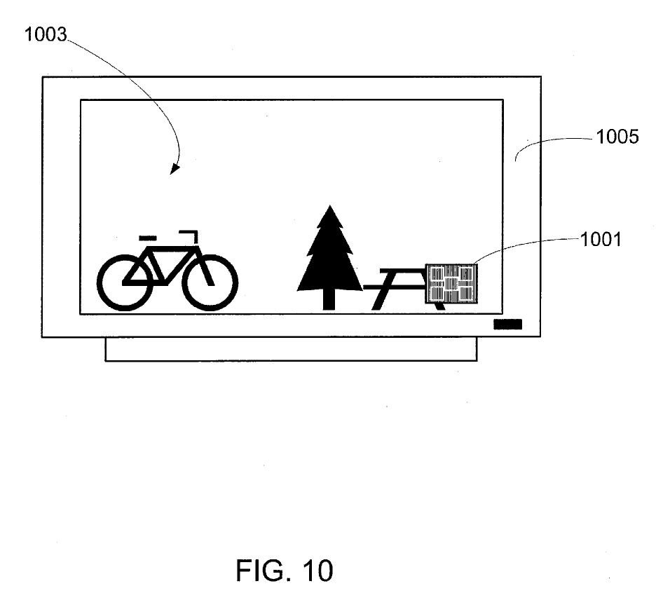

Turning now to salient details of an embodiment as further illustrated in FIG. 10, the broadcaster sends the QR CODE or other code 1001 either within or accompanying the content of interest 1003 to be displayed on the display device 1005. It will be appreciated that the code 1001 may be displayed over material associated with the content 1003, e.g., a guide entry or synopsis screen in addition to or instead of displaying the code 1001 over the content 1003 itself. To allow the use of different content sellers by different users, the code 1001 is preferably content-specific but not provider-specific.

In an embodiment, the code 1001 is provided as an overlay ad on the content 1003. Those of skill in the art will appreciate that the implementation of an overlay ad is media dependent. That is, depending on the type of media being used, the code may be merged with the underlying content prior to transmission or may be sent as a separate file to be merged later by the viewing device. For example, if the media is compliant with the MPEG-4 standard, the overlay ad need not be merged prior to transmission, but may be sent as a separate file, enhancing the clarity of the overlaid code 1001.

Moreover, because readers of QR CODES, bar codes, and other scannable codes operate by sensing contrast, it is preferred that the code 1001 be presented as an opaque overlay rather than a transparent overlay. For example, if a black and white code field is transparently displayed over a black background, the reader may not be able to perceive the white portions of the code 1001 and thus may fail to interpret the code 1001.

It will be appreciated by those of skill in the art that the display of scannable codes on electronic displays presents certain challenges relative to the display of scannable codes on solid objects. In particular, light-emitting media such as televisions, computer monitors and handheld device screens are susceptible to glare or reflections, and so the displayed code 1001 should be of high contrast and should also provide at least some error correction capability. Moreover, due to differences in DPI among different makers, the code 1001 may be made to accommodate the lowest DPI rating that is still consistent with proper display on more prevalent high-DPI devices. It may not be possible to accommodate the very lowest DPI devices since this would render the code 1001 too large on a high-DPI device.

In addition to DPI ratings, other variabilities between display devices and image capture systems (e.g., phone cameras) may be accommodated. For example, due to display device interlacing and differences in digital imaging device CCD (Charge Coupled Device) implementations, each code 1001 could be tested for robust perception and conversion prior to widespread use. In the event that a code proves difficult to read, its size and resolution may be increased, for instance.

Although the code 1001 is illustrated as being in the lower right corner of the display device 1005 screen, it will appreciated that the code 1001 may be displayed elsewhere on the screen, and that multiple such codes may be displayed. Due to the preferred opacity of the code field, there are practical limitations on placement of the code 1001 in certain situations, e.g., the code 1001 should not be placed so as to obscure important material in the underlying content, but should nonetheless be placed and situated so that it is easily seen and accessed by the user.

In operation, the user may scan the code 1001 with their mobile device, which may be an IPHONE, ANDROID PHONE, cell phone, personal computing device, tablet, and so on. The mobile device must provide for the scanning via an optical sensor such as a camera or other scanning device. The mobile device is also capable of processing the scanned code 1001 as will be described in detail hereinafter.

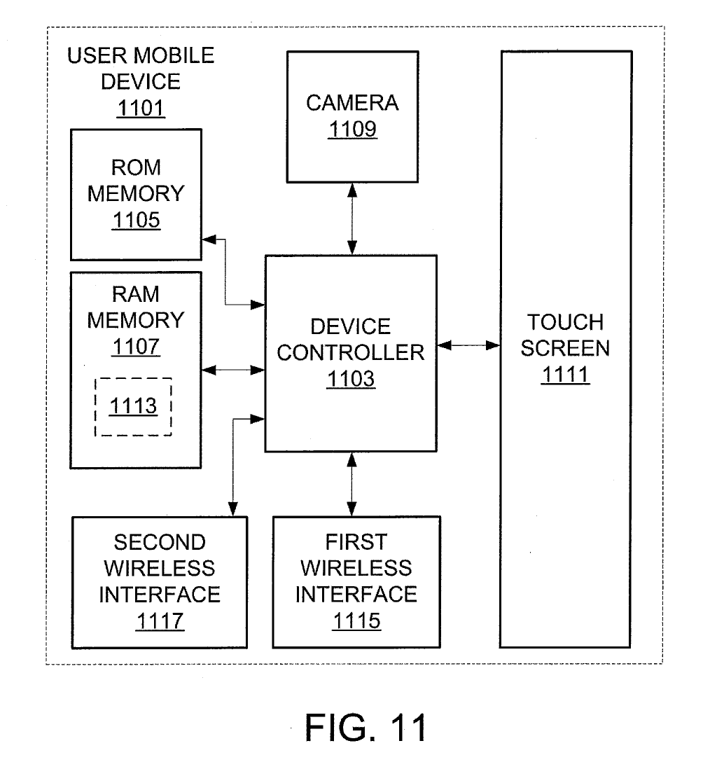

FIG. 11 is a schematic illustration of a mobile user device 1101 suitable for implementing various embodiments of the disclosed system and method. The mobile user device 1101 may be any of an IPHONE, ANDROID PHONE, IPAD, cell phone, lap top computer, or other mobile personal electronic device. In the illustrated architecture and configuration, the mobile user device 1101 includes a device controller 1103, a ROM memory 1105 which is generally nonvolatile, and a RAM memory 1107 which may be volatile or nonvolatile. Each such memory 1105, 1107 is a computer-readable memory implemented in hardware and is non-transitory. The device controller 1103 is a processor or processor-based device which reads computer-executable instructions from one or more nontransitory memories such as memories 1105 and 1107 and executes the read instructions. Data generated by or used by the device controller 1103 in execution of instructions may be stored in memory as well.

The mobile user device 1101 includes a digital imaging device 1109 linked to the device controller 1103 such that the device controller 1103 utilizes the camera 1109 to gather image data when requested. In this connection, the mobile user device 1101 also includes a user interface in the form of a touch screen 1111. Additional user interface elements such as power and reset buttons and so on may also be included, though not illustrated here. Moreover, while the illustrated configuration utilizes a touch screen 1111 for user interface (i.e., for conveying information to the user and receiving input from the user), such is not critical, and certain devices such as laptop computers may have standard screens as opposed to touch screens Moreover, the device may include a user interface for voice recognition. Such an interface includes elements for the capture and interpretation of spoken commands, e.g., “call,” and/or spoken data, e.g., “Sally.”

In order to communicate remotely, the mobile user device 1101 includes a first wireless interface 1115 and a second wireless interface 1117. The first wireless interface 1115 may be, for example, a cellular interface to a cellular network, while the second wireless interface 1117 may be a WiFi, BLUETOOTH or other wireless communication interface.

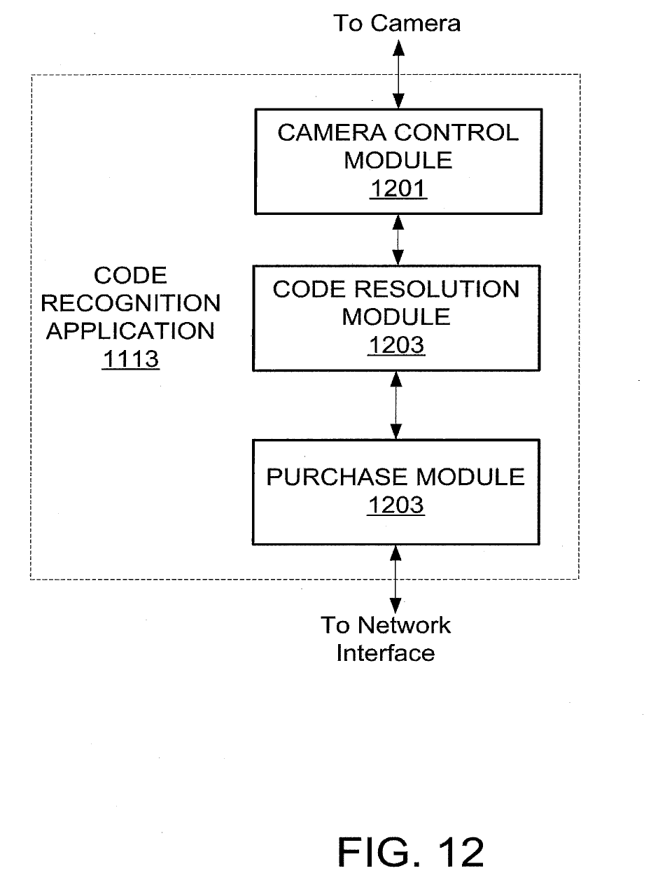

In an embodiment, a code recognition application 1113 is instantiated on the mobile user device 1101, e.g., within RAM Memory 1107 or otherwise, after being read from ROM Memory or received over one of the first wireless interface 1115 and the second wireless interface 1117. The code recognition application 1113 is schematically illustrated in FIG. 12, and includes a digital imaging device control module 1201 for interfacing with the digital imaging device 1109 of the mobile user device 1101, a code resolution module 1203 for receiving and interpreting the scanned code, and a purchase module 1205 for reading user preferences from memory and automatically setting up a purchase or rental for user acceptance, or election and then acceptance if options must be selected prior to purchase. For example, a user may need to indicate that they wish only one episode of a show, or that they wish an entire season of the show, prior to selecting an acceptance option to finalize the purchase.

In an embodiment, the user's preference for a purchase site are prestored in the mobile device. The user preferences may be entered into the device by the user at any time prior to the purchase, e.g., when acquiring and setting up the code recognition application 1113. For example, the user preferences may specify that the user prefers to purchase from ITUNES if available, and may include user logins and passwords and commercial information to set up the transaction. This allows a user to easily purchase content, and also allows the broadcaster and any intermediate provider to easily sell the content.

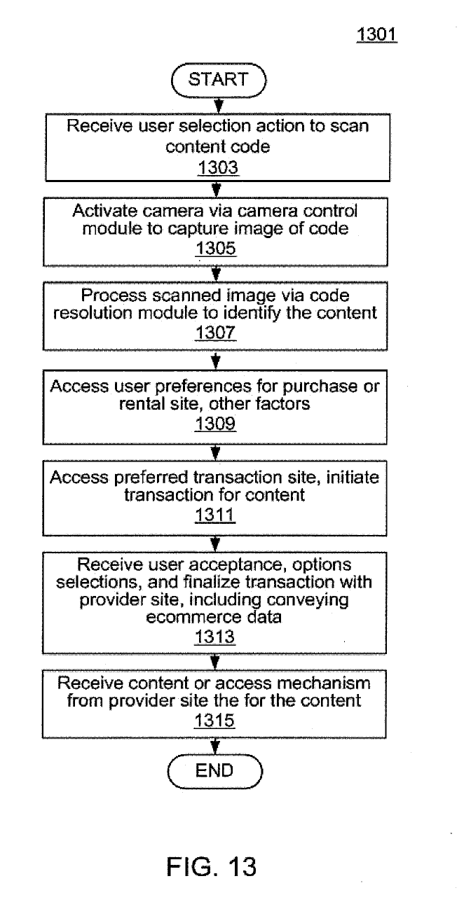

An exemplary process executed by the code recognition application 1113 is shown in the flow chart 1301 of FIG. 13. At step 1303 of the process 1301, the application 1113 receives a user selection action via a user interface as discussed above to scan a content code. This indicates that the user has positioned the device so as to present the code to the digital imaging device 1109. In response to the user action, the application 1113 activates the digital imaging device 1109 via the digital imaging device control module 1201 to capture an image of the code at stage 1305. Although the specific protocol for interfacing with an onboard digital imaging device will vary among device types, those of skill in the art will be aware of such protocols.

At stage 1307, the application 1113 processes the scanned image via the code resolution module 1203 to identify the content upon which the code was displayed. Based on the identified content, the application 1113 accesses user preferences regarding purchase/rental site (e.g., ITUNES, AMAZON, etc.) and any other relevant factors (e.g., a set user preference for single episodes or a set user preference to rent as opposed to purchase) in stage 1309. In keeping with the user preferences, the application 1113 then accesses the preferred transaction site at stage 1311 through the appropriate wireless interface 1115, 1117 and initiates a transaction for the content.

As noted above, in addition to user approval of the transaction, e.g., by pressing “OK” or a similar acceptance icon, the user may be required to enter or select certain options prior to acceptance. At stage 1313, the application 1113 receives a user acceptance including any options, and formalizes the transaction with the provider site, including conveying any ecommerce data such as address, credit card number, PAYPAL account information, and etc. Finally at stage 1315, the application receives from the provider site the content, downloaded or streaming, or an access mechanism (e.g., code or PIN) for the content.

In summary and overview, the described novel architecture, in combination with the optional enhancements as discussed above as desired, provides a system and method whereby a user may easily purchase or rent content via symbology and associated interpretation and programmed actions. Similarly, a broadcast content provider can easily expose a purchasing or renting option to users, avoiding a more complex and less popular transaction. While only certain examples of the described system and method have been set forth, alternatives and modifications will be apparent to those skilled in the art based on the above description.

What is claimed is:

1. A method for accessing broadcast content for acquisition by a user, the method comprising:
electronically recording on a mobile user device symbology visual code displayed with the broadcast content;
automatically resolving the recorded visual code into an identification of the broadcast content at the mobile user device; and
retrieving stored user preferences at the user device, the stored user preferences including at least one remote server for acquiring the broadcast content, automatically connecting from the mobile user device to the at least one remote server and automatically providing ecommerce data from the mobile user device to the at least one remote server to complete an acquisition of the broadcast content.

2. The method for accessing broadcast content for acquisition in accordance with claim 1, wherein the symbology visual code is a visual overlay on the broadcast content.

3. The method for accessing broadcast content for acquisition in accordance with claim 1, wherein the symbology visual code is a QR Code.

4. The method for accessing broadcast content for acquisition in accordance with claim 1, wherein the symbology visual code is a bar code.

5. The method for accessing broadcast content for acquisition in accordance with claim 1, wherein the symbology visual code is a MICROSOFT tag code.

6. The method for accessing broadcast content for acquisition in accordance with claim 1, further comprising receiving a user action to initiate the step of electronically recording,

7. The method for accessing broadcast content for acquisition in accordance with claim 6, wherein the step of electronically recording comprises recording an image of the symbology visual code via a digital imaging module within the mobile user device.

8. The method for accessing broadcast content for acquisition in accordance with claim 1, wherein the ecommerce data comprises payment information associated with the user.

9. The method for accessing broadcast content for acquisition in accordance with claim 1, wherein the stored user preferences further include an indication of whether the user prefers acquisition by rental or by purchase.

10. The method for accessing broadcast content for acquisition in accordance with claim 1, wherein the stored user preferences further include an indication of whether the user prefers acquisition of an episode of content or a season of content.

11. A method for providing access to broadcast content for acquisition by a user, the method comprising:
preparing broadcast content for automatic acquisition by combining the broadcast content and a visual code decodable to identify the content; and
transmitting the broadcast content to a user display appliance such that the visual code is visible over a portion of the broadcast content, whereby a user device can scan the visual code and identify the broadcast content.

12. The method for providing access to broadcast content according to claim 11, wherein combining the broadcast content and the visual code further includes merging the visual code into data corresponding to the broadcast content.

13. The method for providing access to broadcast content according to claim 11, wherein combining the broadcast content and the visual code further includes associating a file corresponding to the visual code with data corresponding to the broadcast content, such that the file corresponding to the visual code and the data corresponding to the broadcast content are merged after transmission.

14. The method for providing access to broadcast content according to claim 11, wherein the user display appliance is a television.

15. The method for providing access to broadcast content according to claim 11, wherein the user display appliance is a computer monitor.

16. The method for providing access to broadcast content according to claim 11, wherein the visual code is a QR code.

17. The method for providing access to broadcast content according to claim 11, wherein the visual code is a bar code.

18. The method for providing access to broadcast content according to claim 11, wherein the visual code is a MICROSOFT tag code.

19. A system for facilitating automatic acquisition of broadcast content, the system comprising:
a user device having a digital imaging device, a controller, and at least one network interface; and
a non-transitory computer memory associated with the user device and having stored thereon instructions for:
scanning a visual code overlaid on visual broadcast content displayed on a display device;
interpreting the scanned visual code to identify the visual broadcast content;
retrieving user preferences stored on the user device, the user preferences identifying a user-preferred site for acquiring the broadcast content; and
establishing a transaction between the user device and the user-preferred site to acquire the broadcast content such that acceptance of the transaction by the user completes the transaction.

20. The system for facilitating automatic acquisition of broadcast content according to claim 19, wherein the visual code is a QR Code.

21. The system for facilitating automatic acquisition of broadcast content according to claim 19, wherein the visual code is a bar code.

22. The system for facilitating automatic acquisition of broadcast content according to claim 19, wherein the visual code is a MICROSOFT tag code

23. The system for facilitating automatic acquisition of broadcast content according to claim 19, wherein establishing a transaction between the user device and the user-preferred site includes retrieving ecommerce data associated with the user on the user device and transmitting the ecommerce data to the user-preferred site.

24. The system for facilitating automatic acquisition of broadcast content according to claim 23, wherein the ecommerce data comprises payment information.
